(19) United States
(12) Patent Application Publication
(10) Pub. No.: US 2017/0146198 A1
(43) Pub. Date: May 25, 2017

(54) LIGHT DIFFUSING DEVICE

(71) Applicant: Elling NIELSEN-WILLIAMS, Davie, FL (US)

(72) Inventor: Elling NIELSEN-WILLIAMS, Davie, FL (US)

(21) Appl. No.: 14/947,807

(22) Filed: Nov. 20, 2015

(51) Int. Cl. F21K 99/00; G03B 15/06; F21V 23/02; F21V 23/00; F21V 3/04; F21V 23/06

(52) U.S. Cl. CPC F21K 9/175; F21V 3/049; F21V 23/06; F21V 23/023; F21V 23/009; G03B 15/06; F21Y 2105/005

(57) ABSTRACT

A device, system, and method for illuminating a subject with diffuse light, the light being generated within more than one plane. The device may include a first light array including a plurality of lights, a second light array including a second plurality of lights, and a third light array including a third plurality of lights, each of the first light array and the second light array being positioned at an angle relative to the second light array, such as approximately 135°. The device may also include an electrical housing located within the tubular body, which may include a power source in communication with the lights and producing power having a wattage, and a printed circuit board in electrical communication with the power source and including a buck regulator that is configured to adjust the wattage of the power source within a continuous range.

### CROSS-REFERENCE TO RELATED APPLICATION

n/a

### STATEMENT REGARDING FEDERALLY SPONSORED RESEARCH OR DEVELOPMENT

n/a

### TECHNICAL FIELD

The present invention relates to a device, system, and method for illuminating a subject with diffuse light, the light being generated within more than one plane.

### BACKGROUND

Light diffusers are frequency used by photographers and videographers to illuminate a subject with softer light. For example, sunlight and photography flashes can produce hard light and shadows, which may be undesirable. Although known diffusers may provide advantages, they are not without their drawbacks. Known photographic and video lights produce light from a single plane of origin, which may produce a harsh falloff at the edges of the light.

Additionally, many known photographic and video lights are dimmable using step dimming (for example, dimming by 10%, 25%, 50%, 75%, and 100%). Further, known photographic and video lights typically use pulse-width modulation (PWM) and boost power regulation, which can cause flickering on camera, lines in photographs, and/or other strange behavior at various dimming intervals.

Finally, photographers and videographers may use any of a variety of products to diffuse or reflect light in order to illuminate a subject with softer light, such as flash diffusers, flash reflectors, and umbrella reflectors. However, reflectors do not generate light and may not precisely direct reflected light and known diffusers diffuse only light coming from a point source, such as a camera flash, and do not evenly distribute generated light over a target length.

It is therefore desirable to provide a device and system that not only generates light in more than one plane of origin, but also evenly distributes diffuse light over a target length and provides a dimmable light without steps.

### SUMMARY

The present invention advantageously provides a device, system, and method for illuminating a subject or object with diffuse light. A device for delivering light to a subject may include a first light array including a plurality of lights, a second light array including a second plurality of lights, and a third light array including a third plurality of lights, each of the first light array and the second light array being positioned at an angle relative to the second light array. The angle relative to the second light array may be greater than 0°. For example, the angle relative to the second light array may be approximately 135°. Each of the first light array, second light array, and third light array may include a plurality of LEDs. The device may further include a body having a first end, a second end, and a longitudinal axis, and a light mount contained within the body, the light mount including a first end, a second end, a first elongate side, a second elongate side, and an interior panel. Each of the first elongate side, the second elongate side, and the interior panel may define a longitudinal axis this is parallel to the longitudinal axis of the body. For example, the first elongate side may be oriented at a 90° angle to the second elongate side. The interior panel may be coupled to the first elongate side and the second elongate side. The body may have a hollow tubular configuration, and further may be composed of frosted acrylic. The device may further include a first cap coupled to the first end and a second cap coupled to the second end.

A device for delivering light to a subject may include: a tubular body having a first end, a second end, and a longitudinal axis; a light mount located within the tubular body, the light mount including a first elongate body, a second elongate body, and an interior panel, each of the first elongate body and the second elongate body being oriented at an approximately 135° angle to the interior panel; an electrical housing located within the tubular body; a first cap at the first end of the tubular body and a second cap at the second end of the tubular body; and at least one aluminum plate located between the electrical housing and the second cap. The tubular body may be composed of a material having a light transmission rate of at least 89%. For example, the tubular body may be composed of frosted acrylic. The device further may include a power source and a printed circuit board, the printed circuit board including a power regulator. The power regulator may be a buck power regulator configured to adjust a wattage of the power source within a continuous range between approximately 7 watts and approximately 21 watts of power. The first elongate body may include a first plurality of LEDs, the interior panel includes a second plurality of LEDs, and the second elongate body includes a third plurality of LEDs. Further, the second plurality of LEDs may include twice as many LEDs as either the first plurality of LEDs or the third plurality of LEDs.

A device for delivering light to a subject may include a tubular body having a first end, a second end, and a longitudinal axis; a light mount located within the tubular body, the light mount including a first elongate body, a second elongate body, and an interior panel, each of the first elongate body and the second elongate body being oriented at an approximately 135° angle to the interior panel; a first LED array on the first elongate body, a second LED array on the interior panel, and a third LED array on the second elongate body; an electrical housing located within the tubular body, the electrical housing being composed of plastic with a mesh interior lining; a power source located within the electrical housing and being in electrical communication with each of the first LED array, second LED array, and third LED array, the power source producing power having a wattage; a printed circuit board located within the electrical housing and being in electrical communication with the power source, the printed circuit board including a buck regulator that is configured to adjust the wattage of the power source within a continuous range; a first cap at the first end of the tubular body and a second cap at the second end of the tubular body; and at least one aluminum plate located between the electrical housing and the second cap. The continuous range may be between approximately 7 watts and approximately 21 watts of power.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a top perspective view of an exemplary light diffusing device;

FIG. 2 shows an exploded view of the light diffusing device;

FIG. 3 shows a close-up exploded view of a first end of the light diffusing device;

FIG. 4 shows a close-up exploded view of a portion of the light diffusing device near a second end;

FIG. 5 shows a close-up exploded view of the second end of the light diffusing device;

FIG. 6A shows a first cross-sectional view of the light diffusing device and distribution of generated light;

FIG. 6B shows a second cross-sectional view of the light diffusing device and distribution of generated light;

FIG. 6C shows a close-up view of the light mount and distribution of light shown in FIG. 6B;

FIG. 7A shows a close-up of the cross-sectional view of FIG. 6A;

FIG. 7B shows a schematic depiction of a cross-sectional view of FIG. 6A;

and

FIG. 8 shows an exemplary system including the light diffusing device.

### DETAILED DESCRIPTION

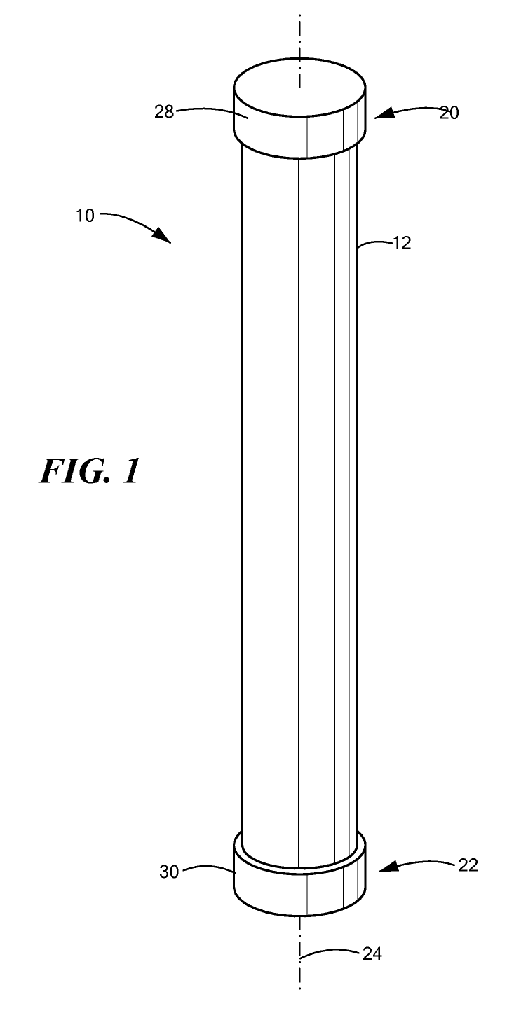

The present invention advantageously provides a device, system, and method for illuminating a subject with diffuse light. Referring now to the drawing figures in which like reference designations refer to like elements, an exemplary light diffusing device is shown in FIG. 1 and generally designated as “10.” The device components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the system and devices disclosed herein are not necessarily exclusive of each other and may be included in a variety of different combinations or configurations without departing from the scope and spirit of the invention.

Continuing to refer to FIG. 1, the light diffusing device 10 may generally include a hollow tubular or cylindrical device body 12, a light mount 14 within the body 12 (not shown in FIG. 1), and a plurality of light sources 16 coupled to the light mount 14 (not shown in FIG. 1). The device 10 may have a first end 20 and a second end 22, a longitudinal axis 24, a length, an outer diameter, an inner diameter, a thickness, and a circumference. As a non-limiting example, the length of the body 12 may be approximately 33 inches (±2 inches), the outer diameter of the body 12 may be approximately two inches, the inner diameter of the body 12 may be approximately 1.75 inches (±0.5 inch), the thickness may be approximately 0.25 inch (±0.1 inch), and the circumference may be approximately 5.5 inches (±1.5 inch). Of course, it will be understood that any length, inner and outer diameters, thickness, and circumference may be used that is suitable for the desired application of the light diffusing device. Further, the body 12 may be composed of frosted acrylic with a matte finish, and may have a light transmission rate of at least 89%, which is higher than currently known diffusion films and offers a 1% lower light transmission rate of single-layered glass. The light transmission rate of the acrylic body is also approximately 14% greater than polyurethane and approximately 17% greater than polyetheretherketone (PEEK).

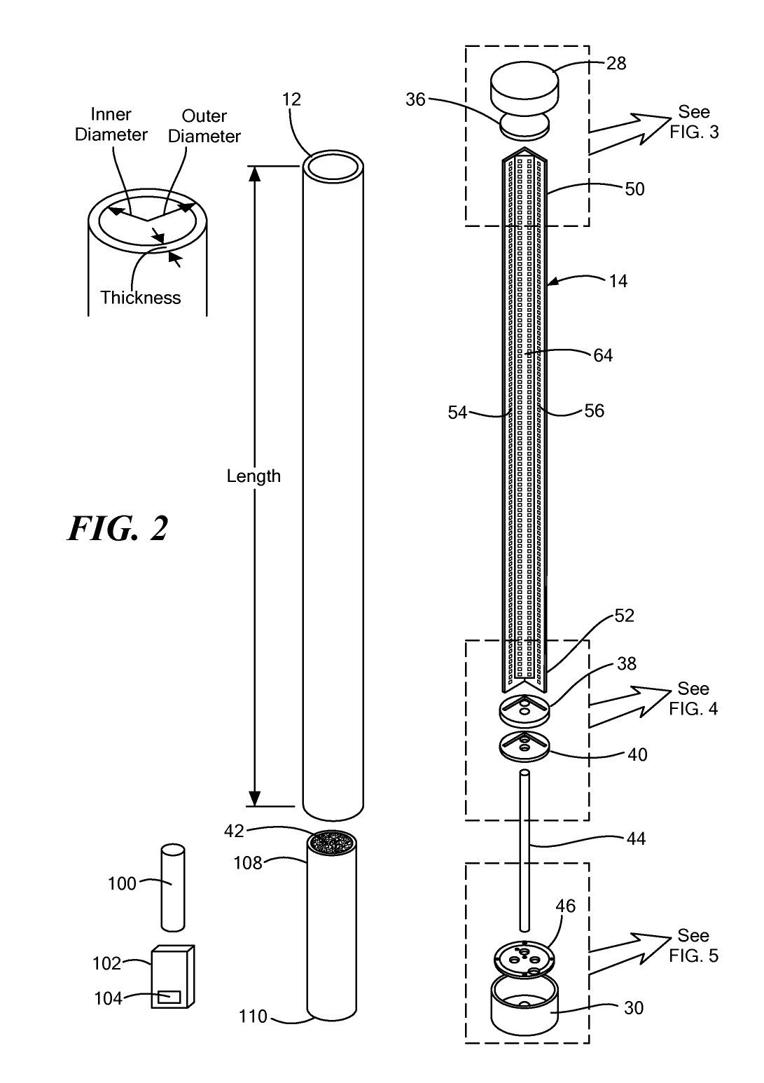

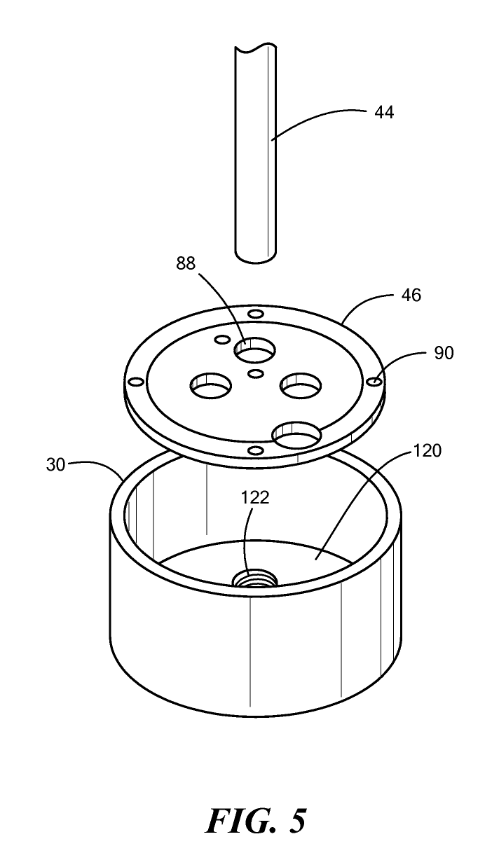

Referring now to FIGS. 2-5, the light diffusing device is shown in a series of exploded views. A first cap 28 may be permanently or removably affixed to the first end 20 and a second cap 30 may be permanently or removably affixed to the second end 22. The first cap 28 may be referred to as the “top cap” and the second cap 30 may be referred to as the “bottom cap,” relative to a tripod attachment point. Each of the first 28 and second 30 caps may be composed of acrylonitrile butadiene styrene (ABS) plastic or a material having similar properties. The second cap 30 may include or contain electronic components and controls for the device 10. Both of the first 28 and second 30 caps may be appropriately sized to engage with the ends 20, 22 of the body 12. Further, the first cap 28 and the second cap 30 may each have an outer diameter that is larger than the outer diameter of the body 12, so that the wider caps 28, 30 may protect the body 12 from damage if the device is dropped.

In addition to the light mount 14, the body 12 may also contain a first interior plate 36 (which may also be referred to as a “top plate”), a second interior plate 38 (which may also be referred to as a “first bottom plate”), a third interior plate 40 (which may also be referred to as a “second bottom plate”), an electrical housing 42, a bolt 44, and a strike plate 46. The light mount 14 may be an elongate A-shaped bracket having a first end 50 and a second end 52. That is, the light mount 14 may have a first elongate side 54 joined to a second elongate side 56 at an angle of approximately 90° (±5°) and the angle of connection between the first 54 and second 56 elongate sides may create an “interior” space 58 of the light mount 14. Each of the first elongate side 54 and the second elongate side 56 may have the same length and width. As a non-limiting example, each of the elongate sides 54, 56 may have a width of approximately one inch (1 inch±0.5 inch) and a length of approximately 24 inches (±2 inches). However, it will be understood that any dimensions may be used that is suitable for the desired application of the light diffusing device. The light mount 14 may be composed of aluminum or similar material, which offers excellent heat dissipation for the lights and power regulation.

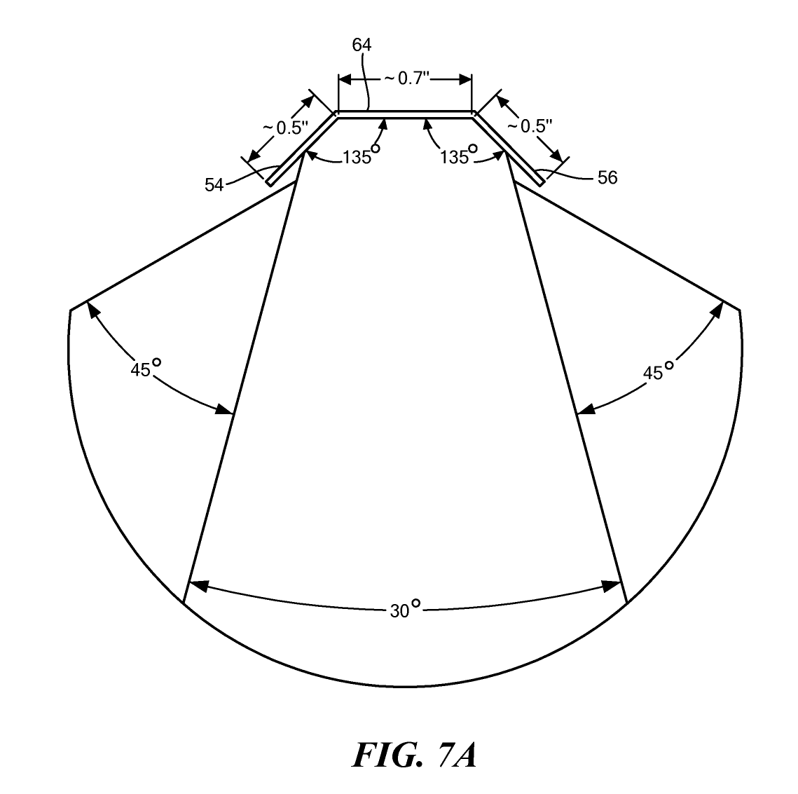

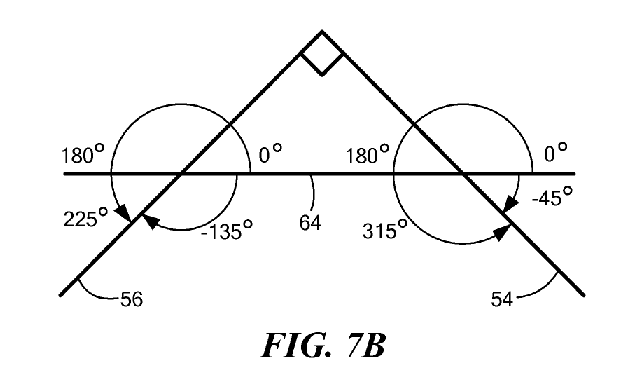

The light mount 14 may further include an interior light mount panel 64 that extends between and is coupled to each of the first 54 and second 56 elongate sides, across the interior space 58 and angle of attachment therebetween. In other words, for example, the interior light mount panel 64 may span the approximately 90° angle of attachment between the first 54 and second 56 elongate sides. As is shown in FIG. 7A, the interior light mount panel 64 may create a first angle of attachment between the first elongate side 54 and the interior light mount panel 64 of approximately 135° (±5°) and a second angle of attachment between the second elongate side 56 and the interior light mount panel 64 of approximately 135° (±5°). As a non-limiting example the width of the interior light mount panel 64 may be approximately 0.7 inches (±0.5 inch) and the length may be less than the length of the elongate sides. Each of the elongate sides 54, 56 may have a width of approximately 1 inch (±0.25 inch), but the portion of the elongate sides 54, 56 on which the LEDs are mounted may be approximately 0.5 inch (±0.1 inch). The interior light mount panel 64 may be affixed to the light mount 14 at a location that is closer to the first end 20 of the device 10 than to the second end 22 of the device 10. As a non-limiting example, the elongate sides 54, 56 may be approximately 0.0625 inch longer than the interior light mount panel 64. Further, the first 54 and second 56 elongate sides and the interior light mount panel 64 may be welded together or may be molded or co-extruded together so the light mount 14 and interior light mount panel 64 together are a single integrated piece.

A first light array 68 including a plurality of light sources 16A, such as light-emitting diodes (LEDs 16A), and may be distributed along the length of the first elongate side 54. Likewise, a second light array 70 including a plurality of light sources 16B (for example, LEDs 16B) may be distributed along the length of the interior light mount panel 64, and a third light array 72 including a plurality of light sources 16C (for example, LEDs 16C) may be distributed along the length of the second elongate side 56. In this manner, as is shown and described in more detail below, a plurality of LEDs 16 may be coupled to an interior surface of each of the first 54 and second 56 elongate sides and to the interior light mount panel 64, thus providing light generation within three planes of origin.

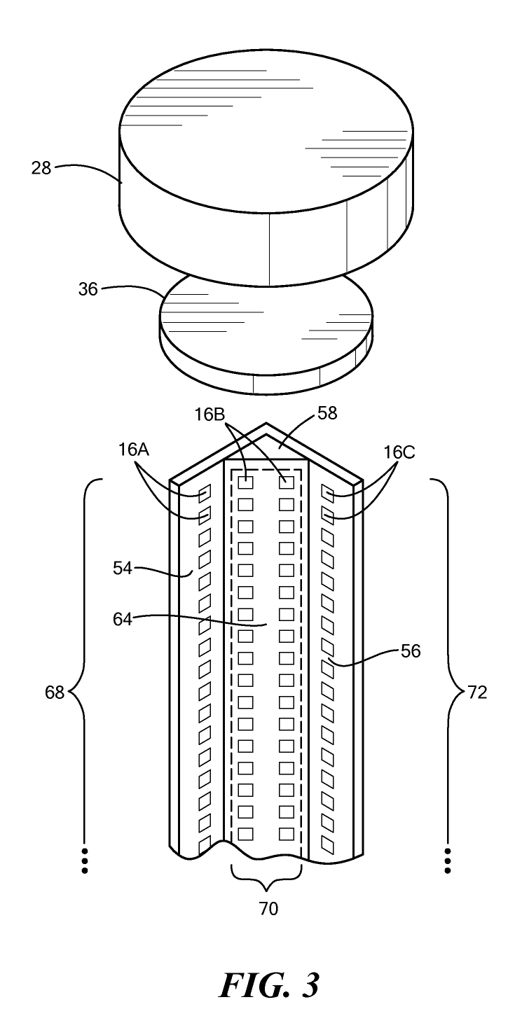

FIGS. 2 and 3 show that the first 68, second 70, and third 72 light arrays may include different numbers of LEDs 16. Of the total number of LEDs 16, the second light array 70 may comprise approximately 50% and the first light array 68 and third light array 72 may each include approximately 25%. This configuration may focus the majority of generated light onto a subject directly in front of the device 10 and may create softer edges and lower falloff rates on the sides of the beam. LEDs 16A, 16C in each of the first 68 and third 72 light arrays may be arranged in a single-file row, whereas the LEDs 16B in the second light array 70 may be arranged in a double-file row, with the LEDs 16B in each of the two rows being either aligned or staggered.

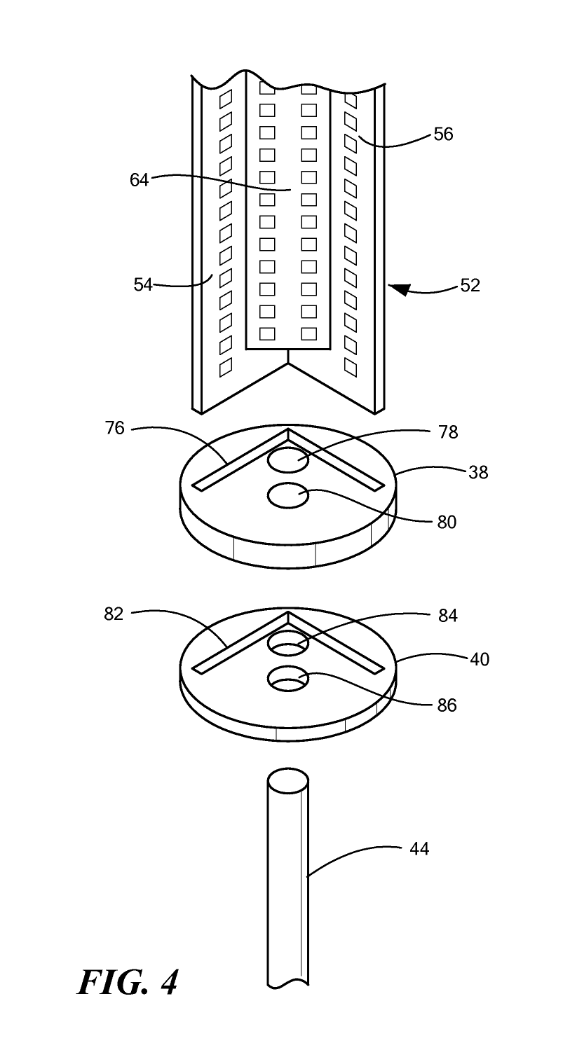

As is shown in FIGS. 2 and 3, the first interior plate 36 may be positioned within the body 12 between the light mount 14 and the first cap 28 and may not include any apertures. Further, the first interior plate 36 may be affixed to the light mount 14 and may prevent damage to and dissipate heat from the LEDs 16. The first interior plate 36 may be a flat circular plate (for example, an aluminum plate) that is sized to fit within the body 12, with a diameter that is approximately the same as the inner diameter of the body 12. Each of the second 38 and third 40 interior plates may also have a diameter that is approximately the same as the inner diameter of the body 12 and may be composed of aluminum or similar material that dissipates heat. The second interior plate 38 may be positioned between the light mount 14 and the third interior plate 40, and the third interior plate 40 may be positioned between the second interior plate 38 and the strike plate 46. The second interior plate 38 may provide heat dissipation for the LEDs 16 and the power regulator, and may be coupled to the electrical housing 42 to hold the electrical housing 42 in place within the device body 12. Further, the second interior plate 38 may lock the bolt 44 to the electrical housing 42 and the light mount 14. As shown in FIG. 4, the second interior plate 38 may include a right-angled (or “V-shaped”) aperture 76 being sized and configured to allow at least a portion of the light mount 14 to pass therethrough, for example, the portions of the elongate sides 54, 56 at the light mount second end 52 that extend beyond the interior light mount panel. The second interior plate 38 may also include an aperture 78 sized and configured to allow at least a portion of the bolt 44 to pass therethrough and an aperture 80 for wiring to pass from the power source to the LEDs 16. The third interior plate 40 may be similar to the second interior plate 38, and may have a right-angled (or “V-shaped”) aperture 82, a bolt aperture 84, and a wiring aperture 86. However, the second interior plate 38 may have a thickness that is greater than the thickness of the third interior plate 40.

Like the interior plates 36, 38, 40, the strike plate 46 may have a diameter that is approximately the same as the inner diameter of the body 12 and may be composed of aluminum or similar material that dissipates heat. The strike plate 46 may be coupled to the body 12 and may provide a solid connection between the bolt 44, electrical housing 42, and device body 12. The strike plate 46 may include a plurality of apertures. For example, the strike plate 46 may include an aperture 88 sized and configured to allow at least a portion of the bolt 44 to pass therethrough. The strike plate 46 may also include one or more additional apertures for a dimmer switch, an aperture for a DC power inlet, an aperture for battery test wires, and a plurality of apertures 90 (for example, threaded screw holes) for coupling the inner components of the device to the device body 12. It will be understood that the interior plates 36, 38, 40 and the strike plate 46 may each include any number and configuration of apertures that makes the plates suitable for their intended purpose.

The electrical housing 42 may be a hollow tubular or cylindrical body sized and configured to be contained within and coupled to the device body 12. The electrical housing 42 may be composed of plastic with a mesh interior lining that is composed of aluminum or other material having similar heat dissipation properties. The electrical housing 42 may contain a power source 100, such as a lithium or lithium-ion battery, a printed circuit board (PCB) 102 that includes a power regulator 104, and various electronic controls. In addition, the electrical housing 42 may also provide stability to connections and spacing between electronic components. The electrical housing 42 may include a first end 108 that is coupled to the third interior plate 40 and a second end 110 that is coupled to the strike plate 46.

The bolt 44 may be composed of aluminum or other material with similar heat dissipation properties, and may provide heat dissipation for the power source 100 and power regulator 104. Further, the bolt 44 may extend within the body 12 from the strike plate 46 to the light mount 14, thereby coupling the light mount 14 to the strike plate 46.

Finally, the second cap 30 may include controls for the device 10, such as a power inlet for operating the device from a direct current (DC) external power source or for charging the battery within the device, a battery level indicator, and a dimmer. The second cap 30 may include a flat surface 120 (for example, that defines the “bottom” of the second cap 30) that includes a tripod mounting aperture 122, which may be threaded. The flat surface 120 of the second cap 30 may also include a battery status display, which may include an activation switch and an aperture therefore and a plurality of LED indicators. The flat surface 120 of the second cap 30 may also include a dimmer knob that is connected to the dimmer within the second cap 30 through an aperture. The PCB 102 may use a step-down or buck regulator as instead of a pulse-width modulation (PWM) or boost regulator, which may allow for smoother and non-stepped dimming, reduction or elimination of flickering, and maintenance of power levels as the battery discharges. The device's wattage may be dimmable or adjustable within a continuous range between approximately seven watts and approximately 21 watts of power.

Although not shown, it will be understood the device 10 may further include screws, snaps, threaded apertures and/or lips, and/or other means for coupling various device components. Additionally, the device 10 may further include a sheet of material (not shown) located between the body 12 and the back of the light mount 14. The sheet may include various types of information such as branding information, or may simply serve as a backing that blocks any transmission of light from the side of the body opposite the LEDs 16. Additionally or alternatively, the light diffusing device 10 may include a sheet or tube of material that makes it possible to adjust the color temperature of the light from the LEDs 16 to the subject to be illuminated. For example, the device 10 may include a gel filter sleeve having a tubular or cylindrical configuration, such as a tube sized as a T12 bulb protector. The gel filter sleeve may be removably inserted into the device around the light mount 14 and LEDs 16, such as by removing the first cap 28, and also may be interchanged with gel filter sleeves of other colors, materials, opacities, or the like to produce the desired photographic effect.

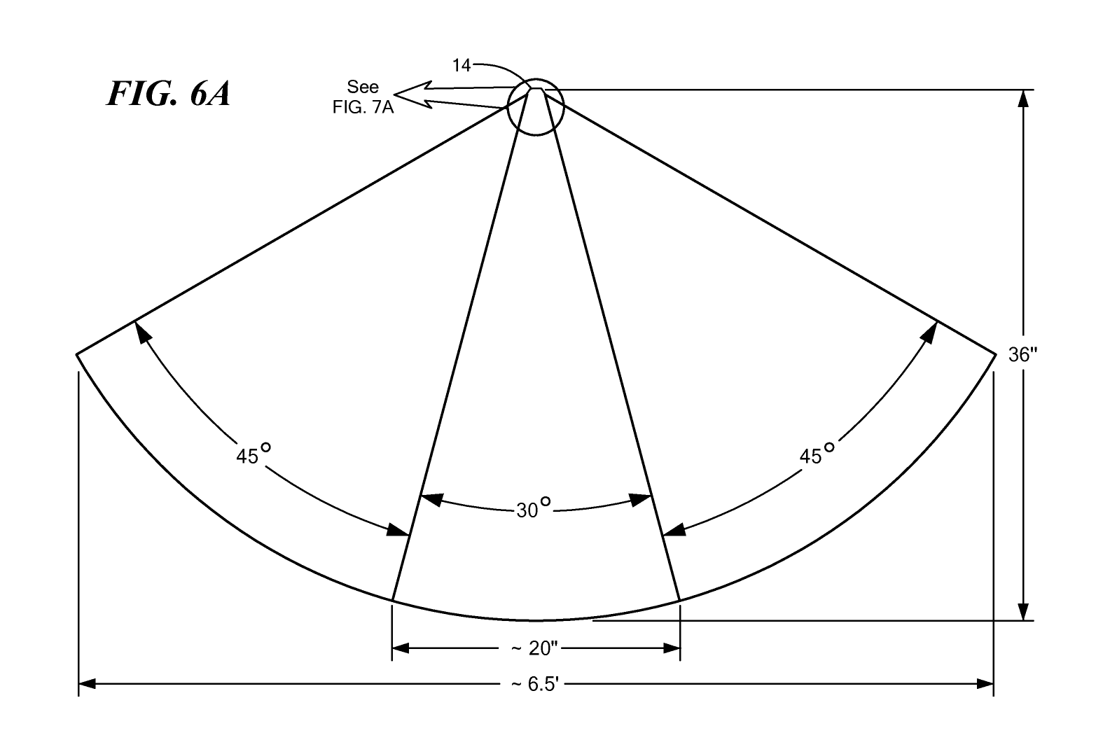

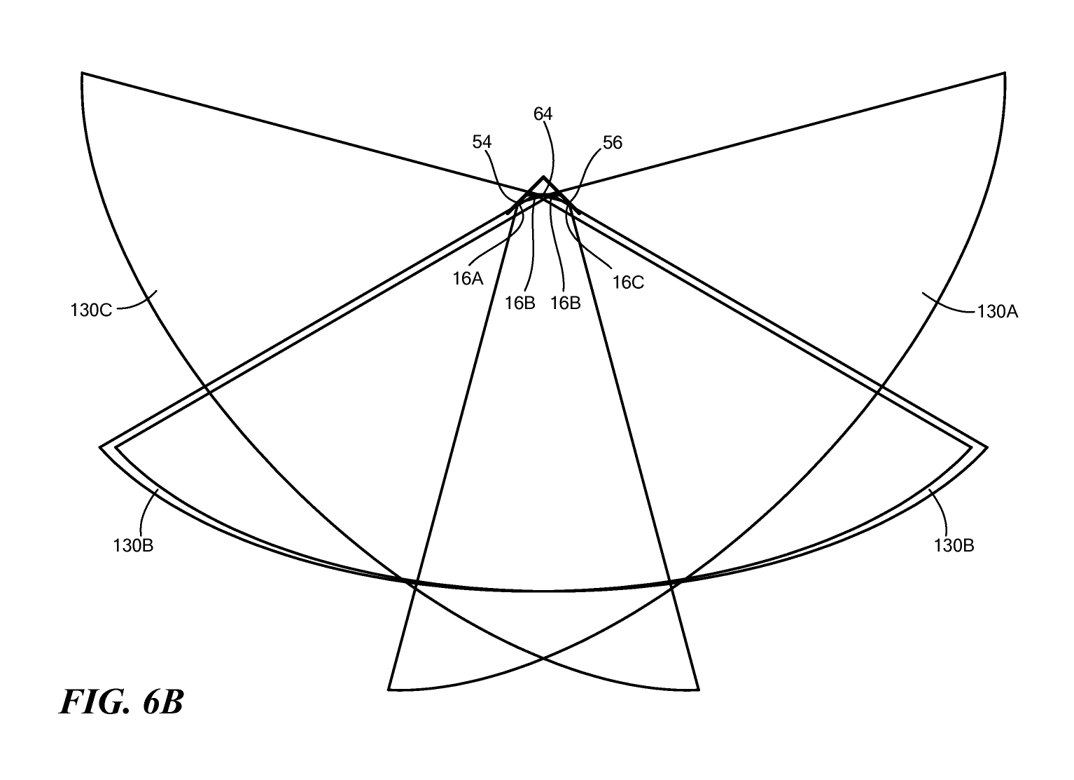

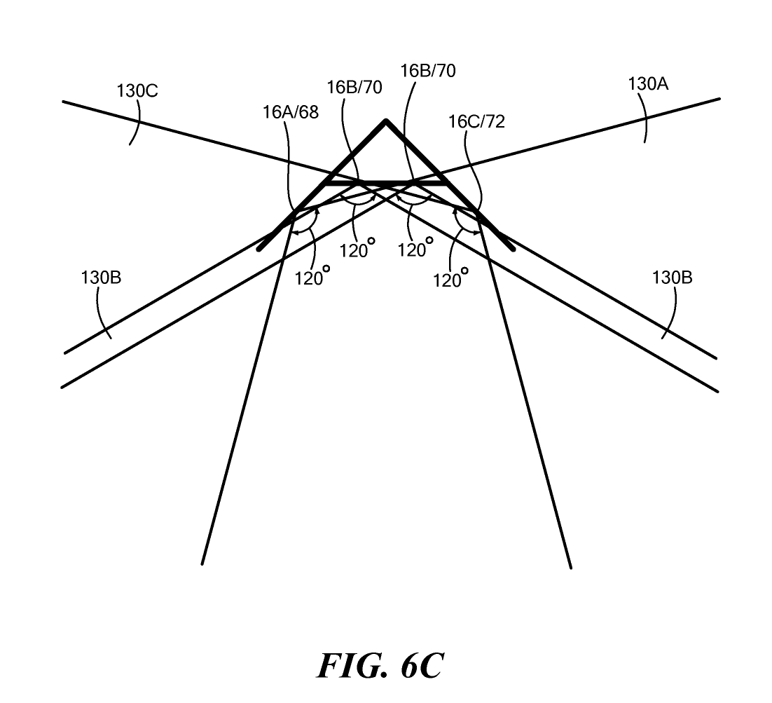

Referring now to FIGS. 6A-7B, cross-sectional views of the light diffusing device and distribution of generated light are shown. Each of the LEDs 16A, 16B, 16C of each of the three light arrays 68, 70, 72 may produce a swath of light 130A, 130B, 130C, respectively, with each LED 16 producing a beam angle of approximately 120° (±5°). One light 16A, 16C from each of the first 68 and third 72 light arrays and two lights 16B of the second light array 70 are shown in the figures for illustration. The composite swath, or the total swath produced by the LEDs 16A, 16B, 16C together may have a beam angle of approximately 160° (±10°) because the light swath 130A produced by the first light array 68 and the light swath 130B produced by the second light array 70 may overlap by a first overlap angle and the light swath produced by the second light array 70 and the light swath 130C produced by the third light array 72 may overlap by a second overlap angle. This configuration of LEDs 16 may produce a focused beam of light that is approximately 20 inches at three feet (36 inches) from the light mount 14, and may further produce a total spread of light that is approximately 6.5 feet. FIG. 6A shows the portion of light directed toward a subject, but FIG. 6B shows swaths of light generated by each of the light arrays as they would be projected if oriented as shown and described immediately above, but without the light mount 14 or any other portion of the device obscuring the light. In other words, FIG. 6B shows the distribution of generated light without interference by the device itself. FIG. 6C shows a close-up view of the light mount and distribution of light shown in FIG. 6B. Each of the LEDs 16 may be balanced to approximately 5200° Kelvin (K), which may facilitate white balancing. At a distance of three feet, the LEDs 16 may provide approximately 2500 lumens to the subject and more than approximately 1875 lumens to the surrounding area.

As noted above, each of the first light array 68 and the third light array 72 may be oriented at an angle of approximately 135° from the second light array 70, as shown in FIG. 7A. In an alternative way of visualizing a cross-sectional view of this configuration (for example, as shown in FIG. 7B), the second light array 70 may be located on an imaginary horizontal line between 180° and 0°, the first light array 68 may be located on a line that is at an angle of approximately 225° from 0° (or approximately −135°) and the third light array 72 may be located on a line that is at an angle of approximately 315° from 0° (or approximately −45°). In yet another way of visualizing the cross-sectional view of this configuration, the first 68 and second 70 light arrays may together define an obtuse angle of approximately 135° and the second 70 and third 72 light arrays may together define an obtuse angle of approximately 135° on the same side of the second light array 70 as the obtuse angle defined between the first 68 and second 70 light arrays.

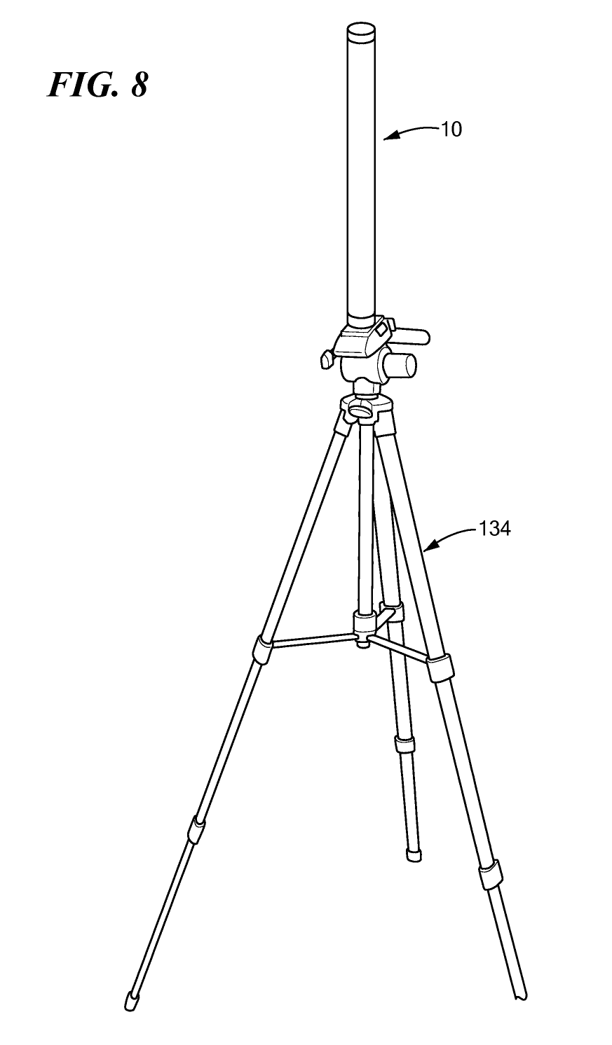

Referring now to FIG. 8, an exemplary system including the light diffusing device is shown. As shown and described above, the device 10 may be coupled to a standard tripod 134 or other stabilizing device (including a camera) via a threaded tripod screw aperture 122. The device 10 may be used with digital cameras, both still and video, and may provide exceptionally soft lighting that is bright enough to compete with most forms of ambient room lighting and can even serve as an effective light fill when filming or photographing in bright sunlight. However, although not shown, the device may also be configured to fit into a T12 fluorescent bulb fixture and used for emergency lighting during a power failure.

In an exemplary method of use, the light diffusing device 10 may be used to broadly distribute diffuse light toward a subject. The first 68, second 70, and third 72 light arrays may be oriented at an angle from each other to produce a swath of diffuse light that has a beam angle of approximately 160°. Specifically, each of the first light array 68 and the third light array 72 may be oriented at an angle of approximately 135° from the second light array 70. The light diffusing device 10 may be affixed to a tripod or other anchoring structure, such as by screwing a tripod screw into the tripod mounting aperture in the second cap 30. Additionally or alternatively, other means for attaching the light diffusing device to a tripod or other anchoring structure may be used, such as clips, snaps, ties, frictional fit, or the like.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A device for delivering light to a subject, the device comprising:
a first light array including a first plurality of lights;
a second light array including a second plurality of lights; and
a third light array including a third plurality of lights,
each of the first light array and the second light array being positioned at an angle relative to the second light array.

2. The device of claim 1, wherein the angle relative to the second light array is greater than 0°.

3. The device of claim 1, wherein the angle relative to the second light array is approximately 135°.

4. The device of claim 3, wherein each of the first light array, second light array, and third light array includes a plurality of LEDs.

5. The device of claim 3, wherein the device further comprises:
a body having a first end, a second end, and a longitudinal axis;
a light mount contained within the body, the light mount including a first end, a second end, a first elongate side, a second elongate side, and an interior panel.

6. The device of claim 5, wherein each of the first elongate side, the second elongate side, and the interior panel define a longitudinal axis this is parallel to the longitudinal axis of the body.

7. The device of claim 6, wherein the first elongate side is oriented at a 90° angle to the second elongate side.

8. The device of claim 7, wherein the interior panel is coupled to the first elongate side and the second elongate side.

9. The device of claim 5 wherein the body has a hollow tubular configuration.

10. The device of claim 9, wherein the body is composed of frosted acrylic.

11. The device of claim 5, wherein the device further comprises a first cap coupled to the first end and a second cap coupled to the second end.

12. A device for delivering light to a subject, the device comprising:
a tubular body having a first end, a second end, and a longitudinal axis;
a light mount located within the tubular body, the light mount including a first elongate body, a second elongate body, and an interior panel, each of the first elongate body and the second elongate body being oriented at an approximately 135° angle to the interior panel;
an electrical housing located within the tubular body;
a first cap at the first end of the tubular body and a second cap at the second end of the tubular body; and
at least one aluminum plate located between the electrical housing and the second cap.

13. The device of claim 12, wherein the tubular body is composed of a material having a light transmission rate of at least 89%.

14. The device of claim 12, wherein the tubular body is composed of frosted acrylic.

15. The device of claim 12, wherein the device further comprises a power source and a printed circuit board, the printed circuit board including a power regulator.

16. The device of claim 15, wherein the power regulator is a buck power regulator configured to adjust a wattage of the power source within a continuous range between approximately 7 watts and approximately 21 watts of power.

17. The device of claim 12, wherein the first elongate body includes a first plurality of LEDs, the interior panel includes a second plurality of LEDs, and the second elongate body includes a third plurality of LEDs.

18. The device of claim 17, wherein the second plurality of LEDs includes twice as many LEDs as either the first plurality of LEDs or the third plurality of LEDs.

19. A device for delivering light to a subject, the device comprising:
a tubular body having a first end, a second end, and a longitudinal axis;
a light mount located within the tubular body, the light mount including a first elongate body, a second elongate body, and an interior panel, each of the first elongate body and the second elongate body being oriented at an approximately 135° angle to the interior panel;
a first LED array on the first elongate body, a second LED array on the interior panel, and a third LED array on the second elongate body;
an electrical housing located within the tubular body, the electrical housing being composed of plastic with a mesh interior lining;
a power source located within the electrical housing and being in electrical communication with each of the first LED array, second LED array, and third LED array, the power source producing power having a wattage;
a printed circuit board located within the electrical housing and being in electrical communication with the power source, the printed circuit board including a buck regulator that is configured to adjust the wattage of the power source within a continuous range;
a first cap at the first end of the tubular body and a second cap at the second end of the tubular body; and
at least one aluminum plate located between the electrical housing and the second cap.

20. The device of claim 19, wherein the continuous range is between approximately 7 watts and approximately 21 watts of power.
